(19) United States
(12) Patent Application Publication
(10) Pub. No.: US 2025/0242432 A1
(43) Pub. Date: Jul. 31, 2025

(54) METHOD FOR MANUFACTURING WORKPIECE AND WORKPIECE

(71) Applicant: HONDA MOTOR CO., LTD., Tokyo (JP)

(72) Inventors: Daisuke Kato, Wako-shi (JP); Yasuharu Kamoi, Wako-shi (JP)

(21) Appl. No.: 19/020,257

(22) Filed: Jan. 14, 2025

(30) Foreign Application Priority Data
Jan. 31, 2024 (JP) 2024-012495

(51) Int. Cl. B23K 26/00; B21D 5/02; B23K 26/382; B23K 101/00

(52) U.S. Cl. CPC B23K 26/0093; B23K 26/389; B21D 5/02; B23K 2101/001

(57) ABSTRACT

A method for manufacturing a workpiece includes a hole forming step and a bending step. In the hole forming step, a plate member is irradiated with a laser light to form a linear through hole penetrating from one surface to the other surface of the plate member, and a holed plate member which is the plate member having the through hole is obtained. In the bending step, at least part of the holed plate member is bent to form a curved section in the holed plate member. In the bending step, the linear through hole is bent to form a curved hole as the curved section is formed.

### CROSS-REFERENCE TO RELATED APPLICATIONS

This application is based upon and claims the benefit of priority from Japanese Patent Application No. 2024-012495 filed on Jan. 31, 2024, the contents of which are incorporated herein by reference.

### BACKGROUND OF THE INVENTION

### Field of the Invention

The present disclosure relates to a method for manufacturing a workpiece and a workpiece.

### Description of the Related Art

Conventionally, it is known to form a through hole in a plate member by irradiating the plate member with a laser beam (see, for example, JP 2020-185613 A).

### SUMMARY OF THE INVENTION

If a through hole can be formed in a plate member at a shallow angle with respect to the surface of the plate member, it is possible to provide the plate member with high cooling efficiency because such a through hole allows cooling air to easily flow along the wall surface of the plate member. However, with the conventional method, it is difficult to form a through hole at a shallow angle in a curved section of the plate member. This is because, if the laser beam is irradiated at a shallow angle with respect to the surface of the curved section of the plate member in order to obtain a through hole having a shallow angle, the laser beam that has passed through the curved section may be further irradiated onto an inner circumferential surface of another part of the plate member, and the irradiated surface will be damaged.

The present invention has the object of solving the aforementioned problem.

A first aspect of the present disclosure is a method for manufacturing a workpiece having a curved section, the method including: a hole forming step of irradiating a plate member with laser light to form a linear through hole penetrating from one surface to another surface of the plate member and obtaining a holed plate member which is the plate member having the through hole; and a bending step of at least partially bending the holed plate member to form the curved section in the holed plate member, wherein as the curved section is formed in the bending step, the linear through hole is bent into a curved hole.

A second aspect of the present disclosure is a workpiece formed of a plate member and includes a curved section, wherein the curved section is formed with a curved hole that penetrates through the plate member from a first surface as one surface of the plate member to a second surface as another surface of the plate member and curves between the first surface and the second surface, and an inner wall of the curved hole is harder than other part of the plate member.

According to the present disclosure, a curved hole can be formed in a curved section by bending a plate member (a holed plate member) in which a through hole has been formed. Since the hole can be formed at a relatively small angle with respect to the surface of the workpiece, a curved plate member having high cooling efficiency can be obtained by passing cooling air through the hole.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a schematic cross-sectional view of a gas turbine engine including a combustor to which a workpiece according to the present embodiment is applied;

FIG. 2 is a cross-sectional view of the workpiece;

FIG. 3 is a flowchart showing a method for manufacturing the workpiece;

FIG. 4 is a view showing a plate providing step;

FIG. 5 is a view showing a hole forming step; and

FIG. 6 is a view showing a bending step.

### DETAILED DESCRIPTION OF THE INVENTION

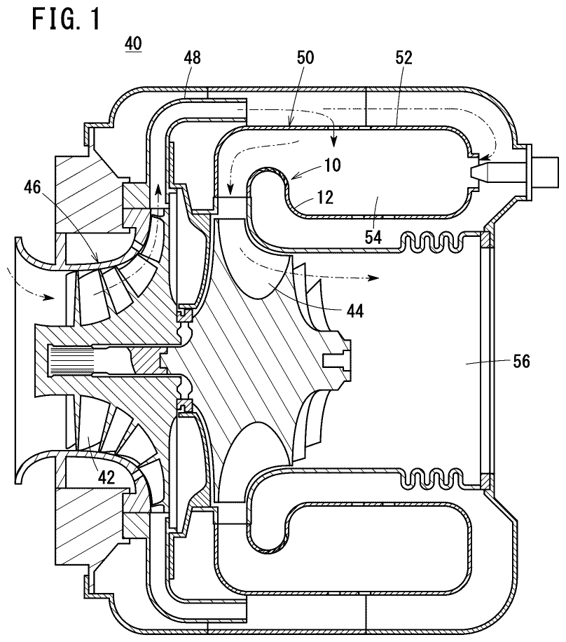

As shown in FIG. 1, a workpiece 10 according to the present embodiment can be applied as, for example, a component of a combustor 50 of a gas turbine engine 40. The workpiece 10 may be applied as a component of an internal combustion engine other than the gas turbine engine 40.

In the gas turbine engine 40, a compressor wheel 42 and a turbine wheel 44 are integrally rotatable. A shroud case 46 is a tubular member that surrounds the compressor wheel 42. Air is introduced into the shroud case 46. The air compressed by the compressor wheel 42 is supplied to the combustor 50 via a diffuser 48.

The combustor 50 mixes the compressed air and a fuel to generate a combustion gas. The combustor 50 includes a liner 52 and a combustion chamber 54. The liner 52 forms a wall of the combustor 50. The liner 52 is made of a metal material that can withstand high temperature caused by the combustion gas. Examples of such a metal material include stainless steel, nickel-based super heat-resistant alloys, and cobalt-based super heat-resistant alloys. The workpiece 10 in FIG. 1 is the liner 52 of the combustor 50. The combustion chamber 54 is a space formed on the inner side of the liner 52.

The combustion gas generated in the combustion chamber 54 of the combustor 50 is supplied to the turbine wheel 44. The combustion gas causes the turbine wheel 44 to rotate. The combustion gas that has passed through the turbine wheel 44 is discharged as exhaust gas via a duct 56.

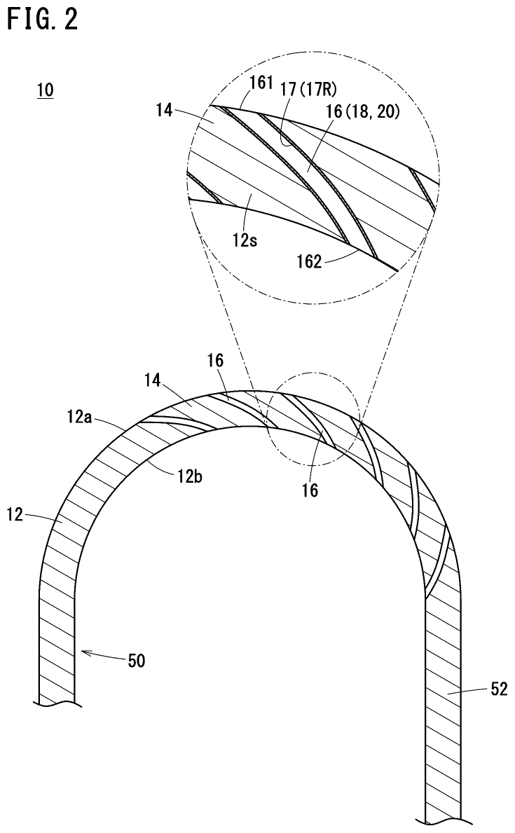

As shown in FIG. 2, the workpiece 10 is formed of a plate member 12. The plate member 12 has a curved section 14. The curved section 14 has been formed by bending the plate member 12 in the thickness direction of the plate member 12. The radius of curvature of the curved section 14 is, for example, 1 to 50 mm. The radius of curvature of the curved section 14 is not limited to the numerical range described above, and may be set as appropriate.

A plurality of through holes 16 are formed through the curved section 14 of the workpiece 10. That is, the workpiece 10 is a component with through holes. The through hole 16 has a first opening 161 and a second opening 162. The first opening 161 is one end of the through hole 16. The first opening 161 opens in a first surface 12a which is one surface of the plate member 12. The second opening 162 is the other end of the through hole 16. The second opening 162 opens in the second surface 12b which is the other surface of the plate member 12.

Each of the through holes 16 is a coolant passage 18 for cooling air. The second opening 162 serves as an inlet from which the cooling air enters the coolant passage 18. The first opening 161 serves as an outlet from which the cooling air is discharged from the coolant passage 18. The through holes 16 are curved holes 20 curved between the first surface 12a and the second surface 12b. The curved holes 20 curve with the curve of the curved section 14. Therefore, the curved hole 20 is curved so as to be convex toward the outer side of the curved shape of the curved section 14. The radius of curvature of the curved shape of the curved hole 20 is, for example, 1 to 50 mm. The radius of curvature of the curved shape of the curved hole 20 is not limited to the numerical range described above, and may be set as appropriate.

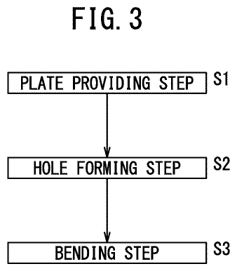

In FIG. 3, the method for manufacturing the workpiece 10 includes a plate providing step S1, a hole forming step S2, and a bending step S3.

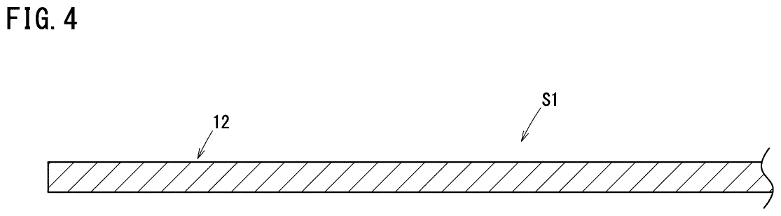

As shown in FIG. 4, in the plate providing step S1, the plate member 12 is provided. The plate member 12 is a flat metal plate in which the through holes 16 (FIG. 2) are not formed. The plate thickness of the plate member 12 is, for example, 0.5 to 4 mm. The thickness of the plate member 12 is not limited to the numerical range described above, and may be set as appropriate.

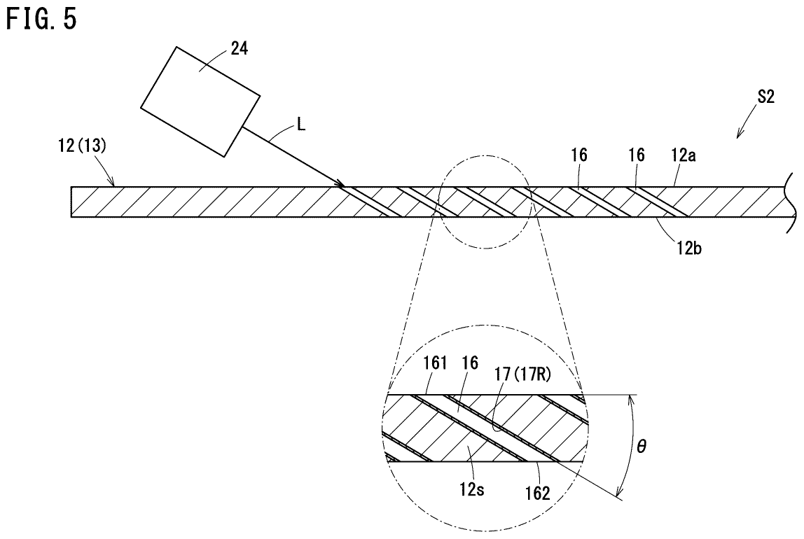

As shown in FIG. 5, in the hole forming step S2, the plate member 12 is irradiated with laser light L to form linear through holes 16 penetrating through the plate member 12 from one surface to the other surface of the plate member 12. Thus, the holed plate member 13, which is the plate member 12 having the through holes 16, is obtained. In the hole forming step S2, a laser device 24 emits the laser light L. The laser light L emitted from the laser device 24 may be a pulse laser or a continuous wave laser. In the hole forming step S2, the plurality of through holes 16 are sequentially formed by changing the relative position of the laser device 24 with respect to the plate member 12.

In the hole forming step S2, the material of the plate member 12 is melted by the laser light L and hardened again thereafter. In this process, the inner wall 17 of the through hole 16 becomes harder than other part of the plate member 12. That is, the hardened layer 17R is formed on the inner wall 17 of the through hole 16. The hardened layer 17R has a tubular shape extending over the entire length of the through hole 16. The other part of the plate member 12 has not been melted by the irradiation of the laser light L in the hole forming step S2. Therefore, the other part of the plate member 12 is the normal part 12s in which the structure of the base metal of the plate member 12 is maintained because the other part has not been thermally affected by the irradiation of the laser light L in the hole forming step S2.

The hardened layer 17R is also formed in the vicinity of the entrance of the laser light L to the plate member 12 and the vicinity of the exit of the laser light L from the plate member 12. The vicinity of the entrance of the laser light L to the plate member 12 is an annular region surrounding the through hole 16 on the first surface 12a of the plate member 12. The vicinity of the exit of the laser light L from the plate member 12 is an annular region surrounding the through hole 16 in the second surface 12b of the plate member 12.

The inclination angle θ of the through hole 16 with respect to the surface (the first surface 12a or the second surface 12b) of the plate member 12 is, for example, 10° to 45°. The inclination angle θ is not limited to the numerical range described above, and may be set as appropriate. The inclination angle θ is the same for the plurality of through holes 16. The inclination angle θ may be different among the plurality of through holes 16. The plurality of through holes 16 may be formed at equal intervals or at unequal intervals.

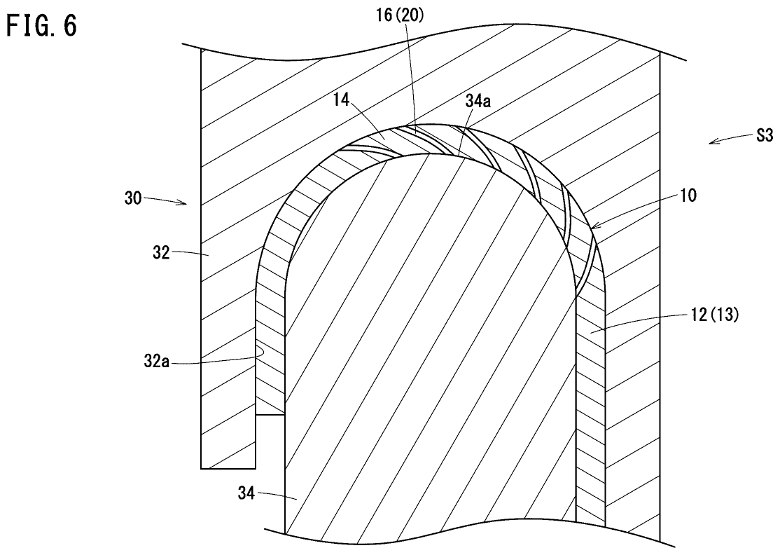

As shown in FIG. 6, in the bending step S3, at least a part of the holed plate member 13 is bent to form the curved section 14 in the holed plate member 13. In this manner, the workpiece 10 with the curved section 14 is formed. In the bending step S3, the linear through holes 16 are bent to form curved holes 20 in the curved section 14 as the curved section 14 is formed.

In the bending step S3, for example, a press device 30 is used. The press device 30 includes a first die 32 and a second die 34. The first die 32 includes a concave section 32a. The second die 34 has a convex section 34a. The holed plate member 13 is bent by being pressed between the concave section 32a of the first die 32 and the convex section 34a of the second die 34. As a result, the workpiece 10 having the curved section 14 in which the curved hole 20 is formed is obtained. The bending step S3 may be performed using equipment or jigs other than the press device 30.

The method for manufacturing the workpiece 10 according to the present embodiment has the following effects.

The curved holes 20 can be formed in the curved section 14 by bending the plate member 12 in which the through holes 16 are formed (the holed plate member 13). Since the through holes 16 can be formed at a relatively small angle with respect to the surface of the workpiece 10, the plate member 12 having high cooling efficiency can be obtained by passing cooling air through the through holes 16.

In the hole forming step S2 shown in FIG. 5, the material of the plate member 12 is melted by the laser light L, and then hardened again thereafter, so that the inner walls 17 of the through holes 16 become harder than other part (normal part 12s) of the plate member 12. According to such a process, the inner walls 17 of the through holes 16 are hardened and become harder than the other part, and therefore, the bending step S3 shown in FIG. 6 is being performed, the through holes 16 can be prevented from being closed. Therefore, the curved holes 20 can be formed in a favorable manner.

In FIG. 1, a workpiece 10 is a component constituting at least a part of a combustor 50. In FIG. 2, the curved holes 20 are the coolant passages 18 for the cooling air. Since the coolant passages 18 of the combustor 50 are constituted by the curved holes 20, the cooling efficiency of the combustor 50 can be enhanced. By increasing the cooling efficiency, the life of the combustor 50 can be extended.

The following supplementary notes are further disclosed in relation to the above embodiment.

### Supplementary Note 1

The method according to the present disclosure for manufacturing the workpiece (10) having the curved section (14) includes: the hole forming step (S2) of irradiating the plate member (12) with laser light (L) to form the linear through hole (16) penetrating from the one surface to the other surface of the plate member and obtaining the holed plate member (13) which is the plate member having the through hole; and the bending step (S3) of at least partially bending the holed plate member to form the curved section in the holed plate member, wherein as the curved section is formed in the bending step, the linear through hole is bent into the curved hole (20) in the curved section.

### Supplementary Note 2

In the method for manufacturing a workpiece according to Supplementary Note 1, in the hole forming step, the material of the plate member may be melted by the laser light and then hardened again, whereby the inner wall (17) of the through hole may become harder than the other part of the plate member.

### Supplementary Note 3

In the method of manufacturing the workpiece according to Supplementary Note 1 or 2, the workpiece may be the component constituting at least part of the combustor (50), and the curved hole may be the coolant passage (18) through which cooling air flows.

### Supplementary Note 4

The workpiece (10) according to the present disclosure is formed of the plate member (12) and includes the curved section (14), wherein the curved section includes the curved hole (20) that penetrates through the plate member from the first surface (12a) as the one surface of the plate member to the second surface (12b) as the other surface of the plate member and curves between the first surface and the second surface, and the inner wall of the curved hole is harder than the other part of the plate member.

### Supplementary Note 5

The workpiece according to Supplementary Note 4 may be a component constituting at least part of a combustor (50), and the curved hole may be a coolant passage (18) through which cooling air flows.

Although the present disclosure has been described in detail, the present disclosure is not limited to the above-described embodiments. These embodiments can be subjected to various addition, replacement, change, partially deletion, and the like without departing from the gist of the present disclosure or without departing from the gist of the present disclosure derived from the contents described in the claims and equivalents thereof. These embodiments may also be implemented in combination. For example, in the above-described embodiments, the order of operations and the order of processes are shown as examples, and the present invention is not limited thereto. The same applies to a case where numerical values or mathematical expressions are used in the description of the above-described embodiments.

1. A method for manufacturing a workpiece including a curved section, comprising:
obtaining a holed plate member which is a plate member having a linear through hole by irradiating the plate member with laser light to form the through hole penetrating from one surface to another surface of the plate member; and
bending the holed plate member at least partially to form the curved section in the holed plate member, wherein
in the bending the holed plate member, the linear through hole is bent into a curved hole in the curved section as the curved section is formed.

2. The method for manufacturing the workpiece according to claim 1, wherein
in obtaining the holed plate member, a material of the plate member is melted by the laser light and then hardened again, whereby an inner wall of the through hole becomes harder than other part of the plate member.

3. The method for manufacturing the workpiece according to claim 1, wherein
the workpiece is a component constituting at least part of a combustor, and
the curved hole is a coolant passage through which cooling air flows.

4. A workpiece formed of a plate member and including a curved section, wherein
the curved section is formed with a curved hole that penetrates through the plate member from a first surface as one surface of the plate member to a second surface as another surface of the plate member and curves between the first surface and the second surface, and
an inner wall of the curved hole is harder than other part of the plate member.

5. The workpiece according to claim 4, wherein
the workpiece is a component constituting at least part of a combustor, and
the curved hole is a coolant passage through which cooling air flows.
